(19) United States
(12) Patent Application Publication
(10) Pub. No.: US 2008/0213062 A1
(43) Pub. Date: Sep. 4, 2008

(54) CONSTANT LOAD FASTENER

(75) Inventors: Alfred David Johnson, San Leandro, CA (US); Michael D. Bokaie, San Rafael, CA (US); Valery Martynov, San Francisco, CA (US)

Correspondence Address: SHAY GLENN LLP, 2755 CAMPUS DRIVE, SUITE 210, SAN MATEO, CA, 94403, US

(73) Assignee: TINI ALLOY COMPANY, San Leandro, CA (US)

(21) Appl. No.: 11/859,697

(22) Filed: Sep. 21, 2007

Related U.S. Application Data
(63) Continuation-in-part of application No. 11/526,138, filed on Sep. 22, 2006.

(51) Int. Cl. F16B 31/04; F16B 35/02; F16B 29/00

(52) U.S. Cl. 411/14.5; 411/395; 411/392

(57) ABSTRACT

Described herein are fasteners and devices for securing together several components so that the load applied to the components is constant or nearly constant. The fasteners described herein include a hyperelastic member having first end to which a first retainer is coupled and a second end to which a second retainer is coupled. The retainers are configured to contact the structures being fastened and transfer the load from the structures to the hyperelastic member. The hyperelastic member may be an elongate shaft (e.g., a rod, cylinder, strut, etc.), and is a shape memory alloy that is typically fabricated as a single crystal.

### CROSS-REFERENCE TO RELATED APPLICATIONS

This application is a continuation-in-part of U.S. patent application Ser. No. 11/526,138, filed on Sep. 22, 2006.

### BACKGROUND OF THE INVENTION

1. Field of the Invention

This invention relates to mechanical devices that have a component in which large recoverable distortions at constant force provide a constant load fastening.

2. Description of Related Art

Ordinary bolts such as those made of steel and various alloys, used to secure two or more components together, are generally tightened by applying a known torque to the nut or stud. It is assumed that the holding force, or load, applied to the components of the joint is proportional to the torque. This is often not true: loads applied by this method may vary by a large factor from one installation to another.

Bolts subjected to high stress also are subject to ‘creep,’ a tendency to lose tension with time, due to a gradual relaxation of the material of which the bolts are made.

It is sometimes desirable to bind two or more objects together in such a way that the pressure exerted on the objects is limited to a known quantity. For example, fasteners exposed to changes in temperature (or regions having different temperatures) may experience differential thermal expansion that can cause the fastener to break. Failure could be prevented if constant tension was maintained by the fastener.

Literature available on the World Wide Web reveals that many inventions have been made to provide solutions to the problem of providing constant load to a bolted joint.

One such prior art method is by use of suitable lubricants on the bolt threads to reduce the variation in friction as the bolt is tightened. This method may be incompatible with the purpose of the joint. For example, this method may result in contamination from lubricants in a bolt used on a space mission.

Another prior art method uses a stack of Belleville washers that are engineered to provide nearly constant force as length is varied. Because Belleville washers generally have spring characteristics (force versus displacement) that are very different from that of the bolt, the forces generated are sufficient for limited applications.

Yet another prior art method provides an array of springs to produce constant force on a clamp. A further prior art method provides an elastic washer that compresses under load.

### SUMMARY OF THE INVENTION

Described herein are new and improved fasteners and devices for securing together several components in such a way that the load applied to the components is constant or nearly constant. Fields of application for the invention include aerospace, military, transportation, mining, construction, seismic retrofitting, medical appliances, and consumer products.

In general, the fasteners described herein include a hyperelastic member having first and second ends to which retainers are coupled. As used herein, a hyperelastic material is a shape memory alloy (SMA) shaft that is fabricated as a single crystal. Single crystal SMAs are defined herein as “hyperelastic” because they can undergo recoverable distortions that are much larger than can be achieved by conventional materials. SMA materials that may be used to fabricate a hyperelastic member (e.g., a hyperelastic shaft) include CuAlNi, CuAlMn and CuAlBe. The retainers are configured to contact the structures being fastened and transfer the load from securing the structures to the hyperelastic member. The hyperelastic member may be an elongate shaft (e.g., a rod, cylinder, strut, etc.).

In some variations, a fastener for holding at least first and second structures together includes an elongate hyperelastic shaft having first and second ends, a first retainer coupled to the first end, wherein the first retainer is configured to secure to the first structure, and a second retainer coupled to the second end, wherein the second retainer is configured to secure to the second structure. The hyperelastic shaft is configured to respond to a load applied on the fastener from the first and second structures by distorting while maintaining the load constant.

The hyperelastic shaft may be made of a single crystal CuAlNi shape memory alloy (SMA), single crystal CuAlMn SMA, or single crystal CuAlBe SMA. The shaft may be a cylindrical shaft, and may be completely or partially hollow. In some variations the shaft is a bolt. The hyperelastic shaft may have a shank that is configured to distort by elongation responsive to the load. In some variations the shaft has proximal and distal ends that have a larger diameter (e.g., radial diameter) than the intermediate region between the proximal and distal ends. For example, the shaft may be a dog-bone shaped rod.

In general, the hyperelastic shaft does not contact the structures(s) to be fastened directly, but receives the load through two retainers that contact the structures to be retained. The retainers are typically attached at or near the distal ends of the hyperelastic shaft. The retainers (e.g., the first and second retainers) may have one or more load-bearing surfaces for engaging the structures to be retained. For example, the first retainer may have a load-bearing surface for engaging a first structure, and the second retainer may have a load-bearing surface for engaging a second structure. The load-bearing surface may be a flange, lip, edge, boss, or the like. In some variations the load-bearing surface is a structure such as a screw.

The retainers couple to the hyperelastic shaft so that the load from fastening the structures(s) is transferred to the hyperelastic shaft. For example, the retainers may be clamps (e.g., for clamping around and coupling to the ends of the hyperelastic shaft), bolts, or the like. The first and second retainers may be coupled to the ends of the hyperelastic shaft so that rotation of either retainer does not substantially torque the hyperelastic shaft. For example, the retainers may be freely rotated without rotating the hyperelastic shaft when the fastener is not loaded. In some variations, the hyperelastic shaft passes through an aperture in the retainer having a diameter that is smaller than the diameter of the end of the hyperelastic shaft, so that the end of the shaft cannot be withdrawn from the retainer, but the shaft can be moved independently of the retainer.

In some variations, the retainer has a cylindrical outer surface that is threaded. Thus, a retainer may be threaded to receive a nut for applying tension to the hyperelastic shaft, or to screw into the structure to be retained.

Also described herein are fasteners for securing a first structure and a second structure together that include an elongate hyperelastic shaft having a proximal end and a distal end, a fist retainer coupled to the proximal end of the hyperelastic shaft so that rotation of the first retainer does not substantially torque the hyperelastic shaft, and a second retainer coupled to the distal end of the hyperelastic shaft so that rotation of the second retainer does not substantially torque the hyperelastic shaft. As mentioned above, the hyperelastic shaft may be made of a single crystal SMA, such as a CuAlNi SMA, CuAlMn SMA or CuAlBe SMA.

The hyperelastic shaft may be a hollow cylinder, a rod, a bolt, etc. For example, the shaft may have a dog-bone shape. In some variations the region between the ends of the shaft (the intermediate region or shank) may be configured to distort by elongation responsive to a load applied to the fastener. For example, the intermediate region may have a smaller diameter than the ends of the shaft.

Also described herein are fasteners for securing a first structure and a second structure together that include an elongate, hyperelastic shaft having a proximal end and a distal end, and an intermediate region between the proximal and distal ends, wherein the intermediate region has a smaller radial diameter than either the proximal or distal ends, a fist retainer coupled to the proximal end of the hyperelastic shaft, and a second retainer coupled to the distal end of the hyperelastic shaft. The hyperelastic shaft may be made of a single crystal CuAlNi SMA, single crystal CuAlMn SMA or single crystal CuAlBe SMA.

Also described herein are methods for securing a first structure and a second structure together. These methods may include the use of any of the fasteners described herein to secure the structures. For example, the method may include the steps of contacting the first structure with a first retainer that is coupled to a hyperelastic shaft, contacting the second structure with a second retainer that is coupled to the hyperelastic shaft, and applying a holding force between the first and second retainer to secure the first and second structures together so that the load applied to the first and second retainers is transferred to the hyperelastic shaft. The hyperelastic shaft responds to a load applied on the fastener from the first and second structures by distorting while maintaining a constant load.

### INCORPORATION BY REFERENCE

All publications, patents, and patent applications mentioned in this specification are herein incorporated by reference in their entirety.

### BRIEF DESCRIPTION OF THE DRAWINGS

FIG. 1 is an axial cross-sectional view of a component comprising a fastener in accordance with one embodiment of the invention, shown in combination with structures such as flanges to which the constant load can be applied.

FIG. 2 is a side elevation view of a fastener in accordance with another embodiment.

FIG. 3 is an end view taken along the line 3-3 of the fastener in FIG. 1.

FIG. 4 is a partially cut-away perspective view of the fastener of FIG. 2.

FIG. 5 is a longitudinal section view of a fastener in accordance with a further embodiment.

FIG. 6 is a longitudinal sectional view of a fastener in accordance with a still further embodiment.

### DETAILED DESCRIPTION OF THE INVENTION

In general, the fasteners described herein include a hyperelastic shaft that is configured to receive the fastening load generated when the fastener secures two or more structures together. The fasteners also include a retainer coupled at each end of the hyperelastic shaft. The retainers typically connect to, and retain the structure(s) to be fastened by the fastener. The retainers therefore include one or more load bearing surface that is configured to contact a structure to be retained. The two retainers couple to the ends of the shaft and transfer the load to the shaft. These retainers do not typically directly contact each other, but are connected by the shaft.

The hyperelastic shaft is typically a shape memory alloy (SMA) shaft that is fabricated as a single crystal. Single crystal SMAs are defined herein as “hyperelastic” because they can undergo recoverable distortions that are much larger than can be achieved by conventional materials. Such distortions are greater than that which could be obtained if the component were made of non-SMA metals and alloys, and nearly an order of magnitude greater than can be obtained with polycrystalline SMA materials. The fabrication and performance of some single crystal SMA materials that may be used as part of the devices (e.g., fasteners) described herein are disclosed in U.S. application Ser. No. 10/588,413 (filed Jul. 31, 2006), the disclosure of which is herein incorporated by reference in its entirety.

The fasteners described herein place the hyperelastic shaft under sufficient stress so that it enters a superelastic plateau when the fastener is engaged. At this stress, small variations in length produce minimal effect on the load applied by the fastening device. There is less risk that the fastening device will break under usage conditions that cause the fastening device to be slightly elongated. Because the shaft is hyperelastic, the shaft may extend or contract if the securing force fastening the structure(s) increases or decreases, resulting in a constant load fastening. The single-crystal SMA material can tolerate huge strains and can elastically deform (e.g., up to 9% deformation along the length of the elongate shaft). The hyperelastic shafts described herein are also extremely durable, and have a long fatigue lifetime, particularly at up to about 1% deformation (which is very large deformation compared to ordinary materials). At greater deformations, the cyclic loading (elongation/contraction) of the shaft may result in fatigue fractures due to dislocation of the crystal structure. For example, at 9% deformation fatigue fractures may occur after approximately 1000 cycles. It is anticipated that during ordinary use of the fasteners described herein, the deformation will be less than 1%. However, during periods of extraordinary deformation the fastener may continue to operate until the load returns to a normal operating range. Thus, the fasteners described herein may be particularly useful in situations in which rare (or even catastrophic) events result in a high load. For example, the fasteners may continue to provide a constant force to fasten structures during a catastrophic event such as an earthquake, in which other fasteners would fail.

As mentioned above, any appropriate hyperelastic material may be used (particularly those described in U.S. Ser. No. 10/588,413 previously incorporated by reference). Examples of alloy components are Cu—Al—X where X may be Ni, Fe, Co, Mn, Be. Single crystals may be pulled from melt as in the Stepanov method and quenched by rapid cooling to prevent selective precipitation of individual elemental components. Conventional methods of finishing may be used, including milling, turning, electro-discharge machining, centerless grinding and abrasion. For example, a single crystal CuAlNi SMA may be particularly useful for forming the shaft.

The shaft may also be any appropriate shape. In general the shaft is an elongate shape extending between a first (e.g., distal) and a second (e.g., proximal) end. The retainers (for connecting to the structures to be fastened) are coupled to the ends (or end regions) of the shaft. In some variations, the shaft is a rod or bolt-shaped shaft. For example, the hyperelastic shaft may be dog-bone shaped shaft having ends that are a larger diameter than the region between the ends (e.g., the intermediate or shank region). This shape may be particularly advantageous when the retainers are coupled by surrounding the smaller-diameter region of the shaft that is slightly intermediate of the distal ends. The shaft and the retainers cannot be separated because the outer diameter (radial diameter) of the distal and proximal ends of the shaft are too large to pass through an opening in the retainers. The deformation of the shaft may take place by the formation of stress-induced martensite; but in elongating (e.g., 9%) in length, the shaft also shrinks in diameter (e.g., 3%), according to Poisson's ratio. Even when the shaft elongates in length and shrinks in diameter under load when fastened, the shaft can stay connected to the retainer because the shaft will preferentially transform to stress-induces martensite at the smaller diameter region first. Thus, shafts having a larger diameter region at their ends may be coupled to the retainers at these ends.

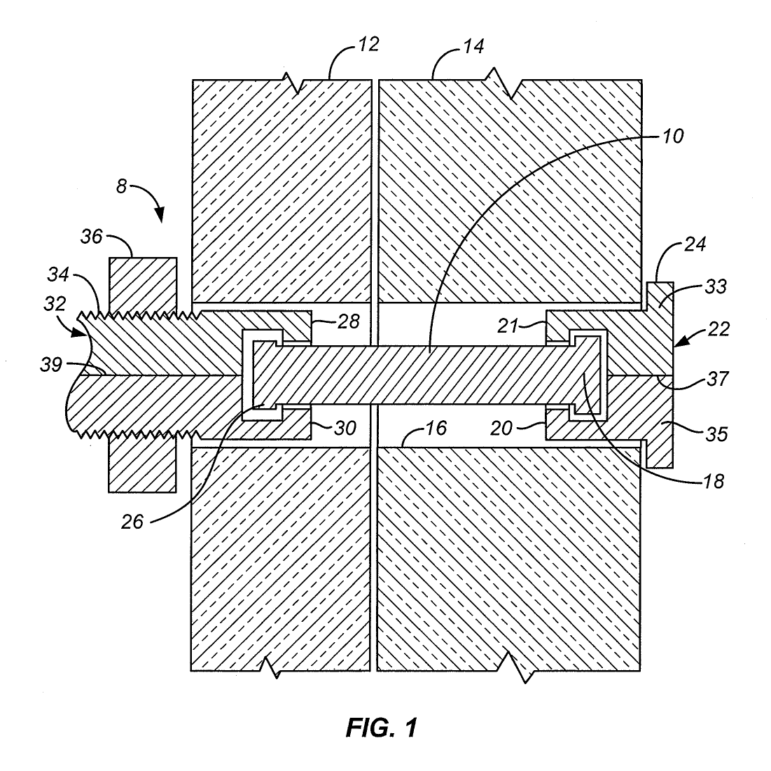

The shaft may be coupled to the retainers in any appropriate way, including clamping, soldering, gripping them, or retaining them with set screws. In some variations it is particularly advantageous to couple the retainers to the shaft so that torque applied to the retainers is not substantially transferred to the hyperelastic shaft. For example, the retainers may be coupled to the shaft so that each retainer may be rotated (torqued) independently of the shaft, particularly when the fastener is not loaded. Examples of retainers coupled to the distal ends of a hyperelastic shaft so that rotation of the retainer does not substantially torque the hyperelastic shafts are shown in FIGS. 1-6, described below. It may be advantageous to reduce or eliminate the transmission of torque between the retainer and the hyperelastic shaft because torque on the hyperelastic shaft may introduce dislocations in the single-crystal structure of the hyperelastic shaft, hastening mechanical failure.

In one variation, the retainer includes an aperture (opening) into which the hyperelastic shaft passes. The shaft is held coupled to the retainer because the end of the shaft has a larger diameter than the aperture. The intermediate region of the shaft has a diameter that is slightly smaller than the diameter of the aperture. Thus the retainer can be secured around the distal end of the shaft, yet still rotate around the shaft freely in the unloaded state. When the fastener is loaded by fastening two structures, the region around the aperture of the retainer may be pressed against a surface of the shaft, and thus some torque on the retainer may be transferred to the shaft. The transfer of torque between the shaft and the retainer in the loaded state may be reduced or eliminated by reducing the friction between the surfaces of the retainer and the shaft that contact when the fastener is loaded. For example, a lubricious material may be located between these surfaces, or the surfaces may be smooth or polished.

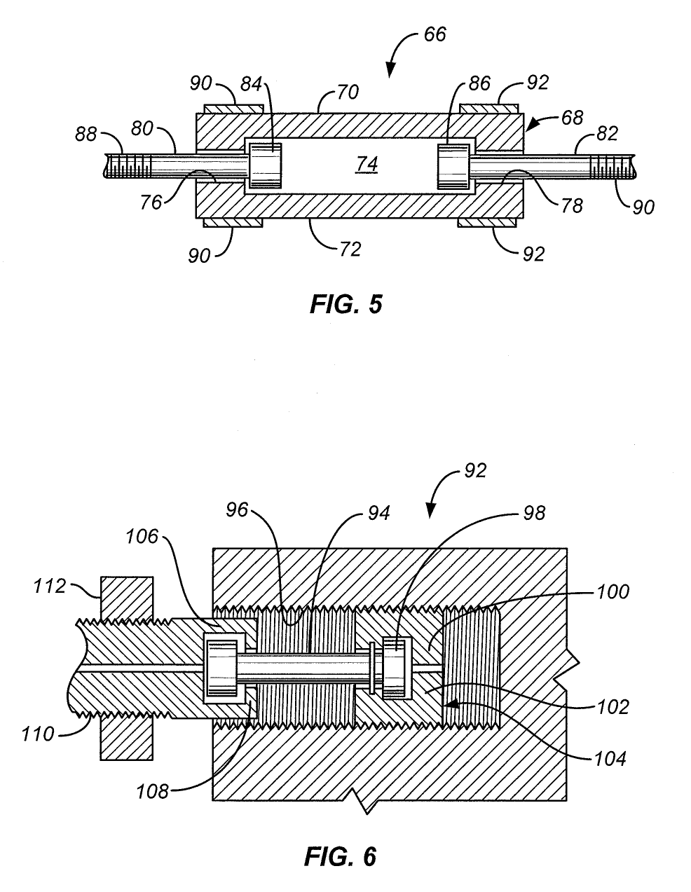

In other variations, the shaft is configured as a cylinder having an aperture through which the retainer passes (see, FIG. 5, described below). Thus, the retainer includes a larger-diameter region that does not pass through the aperture at the end of the cylindrical shaft.

A retainer retains the structure or structures that are secured by the fastener when the fastener is engaged. A retainer may be any appropriate shape. A retainer may include one or more load-bearing surfaces for contacting the structure(s) to be retained. In some variations this load-bearing surface is configured to abut the structure(s) and secure the structure when the fastener is engaged. For example, the retainer may have a boss, flange, lip, rim, etc. The retainer may be configured to mate with another device (e.g. a screwdriver, wrench, lock, etc.). In some variations the retainer includes a threaded surface or a screw. For example, the retainer may be threaded for screwing into a structure. In some variations the retainer is threaded for engaging a nut that can be used to tighten the fastener and secure the structures in position. In some variations the retainer may be welded or otherwise affixed to the structure to be fastened.

Although a fastener typically includes two retainers (one at either end of the hyperelastic shaft), the two retainers of the fastener may be different shapes. For example, one retainer may be cylindrical, and my include threads for engaging a nut while the other retainer is a bolt-headed structure (e.g., at least partially polygonal in cross-section).

A retainer may be a unitary structure (e.g., a single piece) or it may be formed from multiple pieces that are joined together. For example, a retainer may be formed from two pieces that are connected around the end of a hyperelastic shaft. In some variations the pieces forming the retainer are welded or otherwise affixed together. Similarly, the retainer may be formed of any appropriate materials. For example, the retainer may be formed of steel (e.g., stainless steel).

FIGS. 1-6 below described different variations of fasteners, and are described below. Although these fasteners exemplify fasteners in which the hyperelastic shaft is elongated when engaged, the shaft may also be engaged in compression or even in bending.

The embodiment of FIG. 1 provides a component comprising a fastener 8 which includes a hyperelastic shaft (bolt 10) used to hold together under constant load separate structures, such as the illustrated flanges 12 and 14. The fastener penetrates the flanges through the through-hole 16. One end of the bolt is formed with a circular head 18 which is captured by the aperture formed 20, 21 by the retainer 22. In this variation the retainer 22 is a split clamp. This retainer is preferably made of steel, with an elongated boss 24 that acts as a load-bearing surface. The other end of the shaft is formed with a circular head 26 which is captured by the aperture formed 28, 30 in the second retainer 32. This second retainer 32 is a split bolt structure that is preferably made of steel and is formed with external threads 34 onto which a nut 36 is mounted. The nut can be tightened to apply the desired holding force or load on bolt 10. As the nut is tightened, the hyperelastic SMA shaft 10 is stressed in linear tension.

The retainers (threaded-end split bolt 32 and bossed-end split clamp 22) are each fabricated in two parts. For example, parts 33 and 35 which form the bossed-end split clamp. The retainers are coupled about the hyperelastic SMA bolt by a weld 37 for the bossed-end split clamp and a weld 39 along each of the two seams where the respective parts meet. This variation of the fastener resembles a cap screw.

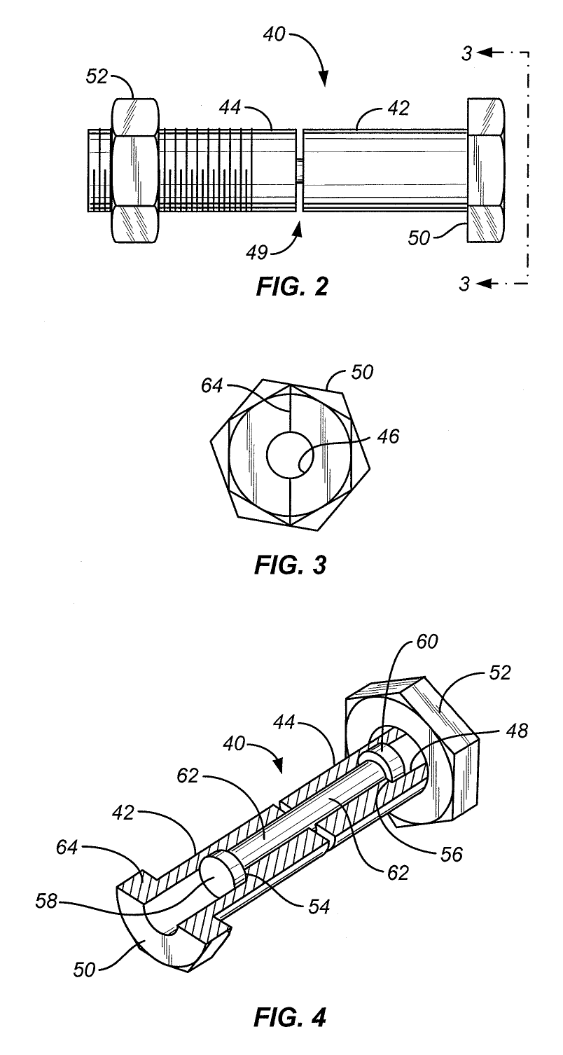

Similarly, the embodiment of FIGS. 2-4 provides an elongated cylindrical fastener that can also be considered a cap screw. The fastener shown in FIGS. 2-4 is comprised of a proximal end retainer 42 and a distal end retainer 44 having respective longitudinally cylindrical bores 46, 48, and an elongate shaft 62. The proximal retainer is formed with a hex-shaped head 50 and the distal end has external threads about which a nut 52 is threaded. Head 50 and nut 52 are adapted to be fitted outside holes formed in a pair of flanges (not shown) through which the proximal and distal ends extend for holding the flanges together. The bores 46, 48 are formed internally with respective shoulders 54, 56 which fit against the opposite heads 58, 60 of the hyperelastic shaft 62.

As best shown in FIG. 3, proximal end retainer 42 with head 50 is formed of two parts that are divided along a radial plane which forms opposing flat surfaces 64. These surfaces are welded together to capture shaft 62 within the fastener.

High tension loads from the flanges when applied to fastener 40 are effectively resisted by hyperelastic shaft 62 which elongates within the bores 46, 48 under constant load conditions. The fastener proximal and distal ends (retainers 42, 44) are sized and proportioned so that a gap 49 is formed between their facing ends (FIG. 2) before nut 52 is tightened on the bolt. This gap provides a clearance.

The embodiment of FIG. 5 provides a fastener 66 that includes a hyperelastic shaft formed as a cylindrical shell 68. This variation is similar to a stud bolt. The two halves 70, 72 of the shaft are joined together to form a hollow cavity 74 having openings 76, 78 at opposite ends. The halves may each be formed of a single crystal hyperelastic SMA material. A pair of retainers (configured as bolts) 80, 82 each have an enlarged head region 84, 86 that extends through the shell openings so that they are captured within the cavity formed in the hyperelastic shaft. This configuration allows the SMA shaft (cylindrical shell 68) to have a larger cross-section of the bolts forming the retainers 80, 82, and thereby match the modulus of elasticity of the bolt material (e.g., steel). The ends of the retainers outside of the elongate shaft are threaded 88, 90 for attachment to any desired flange or other structures. The halves of the hyperelastic shaft may be joined together by a tie, a band, or the like. In FIG. 5, the ends of the shaft are encircled by two bands 90, 92 which secure together the two halves forming the hyperelastic shaft. These bands may be metal, rubber, polymeric, etc., and may preferentially be placed around a thicker region of the hyperelastic shaft, which is less likely to shrink by stress-induced martensite transformation.

FIG. 6 provides a fastener structure 92 that comprises a hyperelastic shaft (bolt 94) similar to the shaft 10 of the embodiment shown in FIG. 1, for mounting within an internally threaded blind hole 96. This variation is an anchor in a dead-end hole. The hyperelastic shaft 94 has an enlarged proximal end 98 that is captured by retainer 104. This retainer 104 is a split-clamp retainer that is formed of two parts 100, 102 that can be enclosed around the enlarged proximal end 98 of the shaft 94. The retainer has an aperture through which the smaller-diameter intermediate section of the shaft 94 extends distally. The split-clamp retainer 104 is externally threaded and can be screwed into the internally threaded hole 96. The distal end of the shaft (bolt 94) is enlarged for engagement with retainer 110, which his shown here as a split bolt having an aperture formed when the two halves 106, 108 are joined. A nut 112 is threaded onto external threads on the split bolt for applying a desired load on the hyperelastic shaft.

While the devices (and method of using them) have been described in some detail here by way of illustration and example, such illustration and example is for purposes of clarity of understanding only. It will be readily apparent to those of ordinary skill in the art in light of the teachings herein that certain changes and modifications may be made thereto without departing from the spirit and scope of the invention.

What is claimed is:

1. A fastener for holding at least first and second structures together, the fastener comprising:
an elongate hyperelastic shaft having first and second ends;
a first retainer coupled to the first end, wherein the first retainer is configured to secure to the first structure; and
a second retainer coupled to the second end, wherein the second retainer is configured to secure to the second structure;
wherein the hyperelastic shaft is configured to respond to a load applied on the fastener from the first and second structures by distorting while maintaining the load constant.

2. The fastener of claim 1, wherein the hyperelastic shaft is made of single crystal CuAlNi SMA, single crystal CuAlMn SMA or single crystal CuAlBe SMA.

3. The fastener of claim 1, wherein the hyperelastic shaft comprises a hollow cylinder.

4. The fastener of claim 1, wherein the hyperelastic shaft comprises a bolt.

5. The fastener of claim 1, wherein the hyperelastic shaft comprises a bolt having a shank configured to distort by elongation responsive to the load.

6. The fastener of claim 1, wherein the first retainer comprises a load-bearing surface for engaging the first structure.

7. The fastener of claim 1, wherein the first retainer comprises a cylinder that is threaded to receive a nut for applying tension to the hyperelastic shaft.

8. The fastener of claim 1, wherein the hyperelastic shaft comprises an intermediate region between the first and second ends having a smaller radial diameter than either the first and second ends.

9. The fastener of claim 1, wherein the first and second retainers are coupled to the ends of the hyperelastic shaft so that rotation of either retainer does not substantially torque the hyperelastic shaft when the fastener is not loaded.

10. A fastener for securing a first structure and a second structure together, the fastener comprising:
an elongate, hyperelastic shaft having a proximal end and a distal end;
a fist retainer coupled to the proximal end of the hyperelastic shaft so that rotation of the first retainer does not substantially torque the hyperelastic shaft; and
a second retainer coupled to the distal end of the hyperelastic shaft so that rotation of the second retainer does not substantially torque the hyperelastic shaft.

11. The fastener of claim 10, wherein the hyperelastic shaft is made of single crystal CuAlNi SMA, single crystal CuAlMn SMA or single crystal CuAlBe SMA.

12. The fastener of claim 10, wherein the hyperelastic shaft comprises a hollow cylinder.

13. The fastener of claim 10, wherein the hyperelastic shaft comprises a bolt.

14. The fastener of claim 1, wherein the hyperelastic shaft comprises a bolt having a shank configured to distort by elongation responsive to a load applied to the fastener.

15. The fastener of claim 10, wherein the first retainer comprises a load-bearing surface for engaging the first structure.

16. The fastener of claim 10, wherein the first retainer comprises a cylinder that is threaded to receive a nut for applying tension to the hyperelastic shaft.

17. The fastener of claim 10, wherein the hyperelastic shaft comprises an intermediate region between the first and second ends having a smaller radial diameter than either the first and second ends.

18. A fastener for securing a first structure and a second structure together, the fastener comprising:
an elongate, hyperelastic shaft having a proximal end and a distal end, and an intermediate region between the proximal and distal ends, wherein the intermediate region has a smaller radial diameter than either the proximal or distal ends;
a fist retainer coupled to the proximal end of the hyperelastic shaft; and
a second retainer coupled to the distal end of the hyperelastic shaft.

19. The fastener of claim 18, wherein the hyperelastic shaft is made of single crystal CuAlNi SMA, single crystal CuAlMn SMA or single crystal CuAlBe SMA.

20. The fastener of claim 18, wherein the hyperelastic shaft comprises a hollow cylinder.

21. The fastener of claim 18, wherein the first retainer comprises a load-bearing surface for engaging the first structure.

22. The fastener of claim 18, wherein the first retainer comprises a cylinder that is threaded to receive a nut for applying tension to the hyperelastic shaft.
